(19) United States
(12) Patent Application Publication
(10) Pub. No.: US 2010/0256272 A1
(43) Pub. Date: Oct. 7, 2010

(54) NANOCOMPOSITES AND THEIR SURFACES

(76) Inventors: Menachem Lewin, Jerusalem (IL); Yong Tang, Anhui (CN)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/723,984

(22) Filed: Mar. 15, 2010

Related U.S. Application Data
(63) Continuation-in-part of application No. 12/593,813, filed on Jun. 3, 2010.
(60) Provisional application No. 60/910,234, filed on Apr. 5, 2007.

(51) Int. Cl. C08K 3/34; C08K 5/5415

(52) U.S. Cl. 524/261; 524/445

(57) ABSTRACT

A method for preparing nanocomposites and nanocomposite polymeric products by dispersing nanoparticles in a polymer either by melt processing or by solution processing and bringing about migration of the nanoparticles from the bulk interior to the surface of the nanocomposites so as to produce a new asymmetric type of nanocomposite in which the concentration of the nanoparticles on the surface is many times higher than in the interior bulk of the nanocomposite. These surfaces impart highly enhanced properties to the nanocomposites as compared to the pristine polymer and to nanocomposites that have not undergone the migration process, including stability against aging, longer shelf life, higher hydrophobicity, higher wear resistance, higher hardness and lower friction. The new surfaces of the nanocomposite polymeric products are produced by inducing migration of the nanoparticles to the surface thereby producing a concentration gradient below the surface.

### STATEMENT OF RELATED APPLICATIONS

This application is a continuation-in-part of U.S. patent application Ser. No. 12/593,813, which is the US National Phase Under Chapter II of the Patent Cooperation Treaty (PCT) of PCT International Application No. PCT/US2008/059140 having an International Filing Date of 2 Apr. 2008, which claims priority on U.S. Provisional Application No. 60/910,234 having a filing date of 5 Apr. 2007, all of which are incorporated herein in their entireties by this reference.

### STATEMENT OF GOVERNMENT INTEREST

This invention was sponsored by the United States National Science Foundation under contract no. NSF (DMR) 0352558 and the US National Institute for Standards and Technology under contract no. NIST 4H1129.

### BACKGROUND OF THE INVENTION

1. Technical Field

The present invention generally is in the fields of (a) preparing nanocomposites based on nonpolar polymers, and (b) preparing new surfaces of nanocomposite products. The present invention more specifically is in the fields of (a) preparing nanocomposites based on nonpolar polymers by dispersing nanoparticles in a polymer in the presence of a mildly oxidizing agent, and (b) preparing new surfaces of nanocomposite products by inducing or accelerating migration of nanoparticles to the surface, thereby increasing the concentration of the nanoparticles on the surface of the nanocomposite.

2. Prior Art

Polypropylene (PP) is the most widely used polymer in the preparation of nanocomposites. It can be preferable to other polymers due to its ready availability, relatively low cost, and many possible applications. However, the apolarity of polypropylene presents difficulties in the dispersion of hydrophilic clays in this hydrophobic polymer. Several systems have been designed and developed to overcome these difficulties. These systems include the addition of polar functional groups to the polypropylene macromolecules. In one system, styrene monomers are copolymerized with propylene. In other systems, OH, NH₂, and carboxyl groups are incorporated, and in a recent development, ammonium ion-terminated polypropylene is prepared. All approaches described until now, however, have not found any practical application due to difficulties in preparation and relatively high cost. See Wang Z. M., et al., Macromolecules 2003, 36:8919; Manias E., et al., Chem. Mater. 2001, 13:3516.

At present, the only modification applied to polypropylene for use in the preparation of nanocomposites is maleation, that is, grafting of maleic anhydride (MA) groups onto the polymeric chain. The maleation treatment is connected with a number of complications including such side reactions as beta-scission, chain transfer, coupling, and above all, severe decrease of the molecular weight. Although interesting modifications of the maleation process were suggested recently, such as the preparation of the borane-terminated intermediate that is prepared by hydroboration of the chain-end unsaturated polypropylene, these modifications have not yet been commercially applied. The maleation process is the only one used at present and is being widely studied for a range of applications, such as metal plastic laminates for structural use, polymer blends, and lately nanocomposites such as polyhedral oligomeric silsesquioxanes (POSS). See Lu B., et al., Macromolecules 1998, 31:5943; Lu B., et al., Macromolecules 1998, 32:2525; Heinen W., et al., Macromolecules 1996, 29:1151.

### BRIEF SUMMARY OF THE INVENTION

The present invention comprises novel methods of preparing nanocomposites and polymeric nanocomposite products by dispersing nanoparticles in a polymer. The dispersion can be accomplished by, for example, dispersing the nanoparticles either in a molten polymer or in a polymer dissolved in a suitable solvent. If the nanoparticles are dispersed in a molten solvent, then, in the case of a nonpolar polymer the dispersion can be carried out in the presence of a mildly oxidizing agent.

The present invention further comprises novel methods of preparing new surfaces of the polymeric nanocomposite products by inducing or accelerating migration of nanoparticles to the surfaces of the matrix polymers in which they are dispersed, thereby increasing the concentration of the nanoparticles on the surface. These enhanced surfaces comprise improved surface mechanical properties, such as but not limited to hardness, wear, abrasion resistance, friction, hydrophobicity, permeability to oxygen, increasing aging resistance, and decreasing photo-oxidation. In this way, asymmetric membranes can also be produced which may enable separation of materials.

In one exemplary embodiment, a nanocomposite is prepared using a nanoparticle such as for example POSS, montmorillonite, or organically treated montmorillonite. Exemplary polymers include but are not limited to polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN). Exemplary oxidizing agents include but are not limited to air, organic peroxides, hydroperoxides and inorganic oxidizing agents such as nitrates. In the case of clay, such as montmorillonite clay, a surfactant can be chemically linked to the aluminosilicate layers. Such a surfactant can be a quaternary ammonium compound including a long aliphatic chain composed of 10 to 18 methyl groups. Clay does not disperse in a polymer which does not contain polar groups. Existing ways to introduce polar groups into a polymer such as pristine polypropylene to compatibilize the polymer are cumbersome. The present invention addresses this problem and provides a simple way to compatibilize such polymers and involves mixing organic peroxides and hydroperoxides, air or oxygen, or inorganic oxidizing agents such as but not limited to nitrates and persulfates or perborates or mixtures thereof, with the molten polymer together with the clay.

The second major problem addressed by the present invention is an improvement in surfaces of nanocomposite structures. The surfaces can be changed and improved by bringing about a migration of, for example, nanoparticles from the interior bulk of the polymer to the surface, thereby enriching the surface with the nanoparticles. Such an enrichment of the surface can be regulated by the extent of migration. For example, the surface can have a concentration of nanoparticles greater than twice the concentration of nanoparticles in the bulk interior of the nanocomposite or nanocomposite product. Such enriched surfaces have enhanced properties as compared to original nanocomposite surfaces. Such nanocomposites with enhanced surfaces can be called “second generation nanocomposites”. One such improvement expresses itself in enhanced hardness of the surface. The invention presents ways to prepare such enhanced surfaces.

### BRIEF DESCRIPTION OF THE DRAWINGS

FIG. 1 illustrates octoisobutile polyhedral oligomeric silsesquioxanes.

FIG. 2 is an AFM image of the surface resulting from Example 29, 41, 46.

FIG. 3 is a SEM image of the surface resulting from Example 46.

### DETAILED DESCRIPTION OF PREFERRED EMBODIMENTS

The present invention comprises two parts. The first part is a novel way of preparing nanocomposites by dispersing the nanoparticle in a nonpolar polymer, preferably in the presence of a mildly oxidizing agent such as air or organic peroxides and hydroperoxides, and other oxidizing agents such as nitrates, persulfates and perborates. The oxidizing agent will produce new polar groups on the polymeric chains such as hydroxyl, ketone, aldehyde and carboxyl groups, and thus bring about a certain degree of polarity to the polymer depending on the extent of oxidation during the mixing. The oxidation has to be carried out in such a way as not to degrade the polymer by splitting the chains and thus shortening them. This will result in a decrease in the mechanical properties such as tensile strength, modulus and elongation-at-break. This may happen when a relatively high concentration of the oxidizing agent is present or when there is a long mixing time in the presence of the oxidizing agent at the elevated temperature of mixing the melt. Those skilled in the art will without difficulty determine the exact amount of a given oxidizing agent to be added during the mixing of the polymeric melt with the nanoparticles.

The concentrations of the oxidizing agents used will depend on at least (a) the nature and the structure of the polymer used and may be different for different polymers and (b) the oxidizing agent used. Each oxidizing agent may need different conditions for a successful application, such as different concentrations and times of application. The concentration and the time of application of the oxidizing agent will also control the degree of the compatibilization of the polymer. This compatibilization can be determined by testing the resulting nanocomposite with small angle X-rays. The results of this XRD test will show the distance between, for example, the two aluminosilicate layers of the clay particles, and is termed the “interlayer distance” (d). The angle obtained in such an X-ray scan of a nanocomposite sample will enable the calculation of (d). The more extensive the compatibilization of the polymer, the more polymeric chains will enter (intercalate) into the gallery between the two aluminosilicate layers. The higher the number of the intercalated chains, the greater the interlayer distance. Thus, the interlayer distance indicates the degree of the compatibilization of the polymer. This XRD scan therefore enables the control of the extent of oxidation and the obtainment of a product with the desired degree of polarity.

The compatibilization process occurs simultaneously with the mixing of the clay with the polymeric melt, and the oxidizing agent can be added at various stages of the mixing. For example, the oxidizing agent can be added to the polymer before the addition of the clay and dispersed in the polymer and only later the nanoparticles are added and the mixing continues. The compatibilization process also can be carried out by adding simultaneously the oxidizing agent together with the clay. The oxidizing agent can be premixed or even pre-reacted with the clay or with the surfactant and then added to the polymer and the mixing process. The oxidizing agent may even form a part or derivative of the surfactant. Another possibility is to use air as the oxidizing agent, which will be pumped into an extruder together with the melt.

The rate and extent of the oxidation by the air can be regulated by applying predetermining mixtures of air with nitrogen. The concentration of the air in the gaseous mixture will determine the extent of oxidation. Those skilled in the art will be able to determine the composition of the gaseous mixture to be used for particular polymers and particular nanoparticles. It is also possible to apply a mixture of oxygen with air or nitrogen with air in the case where rapid compatibilization will be needed for polymers at lower temperatures. Another possibility is to apply simultaneously an oxidizing agent such as a hydroperoxide, together with air or air-nitrogen mixtures. We have surprisingly found that when applying this approach to the compatibilization of polymers for nanocomposites, conditions can be determined by which no significant loss of the mechanical properties and no significant degree of degradation can be obtained.

The second part of this invention pertains to the migration of nanoparticles to the surface of the nanocomposite and the creation of new surfaces. The phenomenon of the migration of clay to the surface upon annealing at elevated temperatures has been discussed recently by one of the present inventors. See Lewin, M., et al., Nanocomposites at Elevated Temperatures: Migration And Structural Changes, Polym. Adv. Technol. 2006, 17:226; Lewin, M., Reflections on Migration of Clay and Structural Changes in Nanocomposites, Polym. Adv. Technol. 2006, 17:758; Zammarano, M., et al., The Role of Oxidation in the Migration Mechanism of Layered Silicate in Poly(propylene) Nanocomposites, Macromol. Rapid Commun. 2006, 27:693; Tang, Y., Lewin, M., Effects of Annealing on the Migration Behavior of PA6/Clay Nanocomposites, Macromol. Rapid Commun. 2006, 27:1545; Tang Y., Lewin, M., Maleated Polypropylene OMMT Nanocomposite: Annealing, Structural Changes, Exfoliated and Migration, Polym. Degrad. and Stab. 2007, 92:53; Tang, Y., Lewin, M., New Aspects of Migration, Oxidation and Slow Combustion in Nanocomposites, Polym. Degrad. Stab., Vol. 93, 2008, pp. 1986-1995; Lewin, M., Tang, Y., The Oxidation-Migration Cycle in Polypropylene based Nanocomposites, Macromolecules 2008, 41:13-17; Huang, N., et al., Studies on the Migration in PA6-OMMT Nanocomposites: Effect of annealing on migration as evidenced by ARXPS (angle resolved x-ray photoelectron spectroscopy), PAT 2008, in print.; Lewin, M., Tang Y., Annealing, Structural Changes, and Migration of Polypropylene Nanocomposites, Polymer Preprints 2007, 48(1):864.

The main cause of migration is the Gibbs adsorption isotherm, according to which in a mixture of several components the component with the lowest surface tension will migrate to the surface of the condensed phase/air interface. This migration is spontaneous and will happen at all temperatures. Its rate, however, will depend on the temperature and therefore, in order to obtain the migration phenomenon and the extent desired, one has to regulate the temperature. Although the Gibbs isotherm is valid for small, as well as for polymeric molecules, we found surprisingly that it is operative also for colloidal dispersions in polymeric melts or solutions. Consequently, we found that the migration occurs for montmorillonite and especially for organically-layered montmorillonite (OMMT) which contains appropriate surfactants. These particles have a very high aspect ratio of several hundred, whereas the thickness of the particle is only 1-3 nm. The length and width of the particle can reach up to 1000 nm or higher. The migration can occur at a range of temperatures from 0 to 400° C. for mixtures of polymers with nanoparticles.

At elevated temperatures under which the polymer starts to decompose and pyrolize, the secondary cause for migration will occur. The gases and bubbles formed in the pyrolysis and combustion of the organic surfactant in the organoclay as well as of the polymeric matrix will drive the clay to the surface. However, in the absence of such gases or bubbles, that is, at temperatures below the onset of the decomposition of the surfactant and of the polymer, the driving force will be thermodynamic, stemming from surface free energy differences between the matrix and the interfacial tension between the matrix and the clay. The interfacial surface tensions were shown to be much lower than those of the polymeric matrices. The moiety migrating to the surface will thus be a clay particle with some matrix molecules adhering to it.

There are two major moieties of the nanocomposite. One is the intercalated moiety that is formed by the intercalation of the polymeric matrix molecules into the gallery that exists between the two layers of aluminosilicate of which the clay is composed. These clay particles containing the intercalated polymeric matrix molecules are organized in relatively large stacks that are visible in high resolution electron microscopy. These stacks are too bulky to migrate to the surface. The migrating species is the exfoliated moiety which is composed of the single layers of clay formed upon splitting the intercalated clay particles. Such exfoliated units are thin. In addition to the aluminosilicate clay layer, they also are composed of adhering surfactant and polymeric matrix molecules. The extent of migration is thus dependent on the extent of intercalation and consequently of exfoliation in the nanocomposite.

In the case of polypropylene, intercalation occurs only when some polarity is imparted to the polymer. Oxidation during annealing of the molten polymer, such as that which occurs when air is used to purge the annealing sample, greatly enhances the extent of migration. In the absence of a suitable compatibilizer for the polypropylene, no migration occurs without oxidation, even in the case when nanoparticles were already dispersed in the polymer and intercalated in the gallery of the clay. Oxidation of a hydrophobic nonpolar polymer is therefore needed for both cases. First it is needed for the dispersion of the nanoparticle of such a polymer in which the intercalation of the polymeric molecules into the gallery occurs. Second, it is also necessary after the dispersion takes place when one wants to obtain the exfoliated moiety.

In addition, migration occurs by annealing the nanocomposite above the glass transition temperature (T_{g}) to accelerate the movement of nanoparticles from the interior bulk of the nanocomposite to the surface. We found that the migration occurs also at ambient temperatures without any annealing or heating. In this case, however, migration is relatively slow. The migration will depend only on the thermodynamic potential created by the difference in the surface tension of the two moieties discussed above. The heating or annealing does not induce the migration. Migration is spontaneous. There is only a certain acceleration of the process brought about by increasing the temperature. This acceleration does not depend on any chemical reactions or interactions between the nanoparticles and the polymer.

This invention relates only to saturated, nonreactive and non-condensable materials. Such reactive materials undergo reactions which change not only their chemical composition and character but also their surface tension, thereby sometimes slowing down the migration process. Such materials are used especially when one intends not to produce an enriched surface with the nanoparticles, but to create a gradient of different concentrations of nanoparticles. The purpose then is the gradient and not the external surface. This is the case in the patent of Dellwo, U., et al., Method for the Production of Optical Elements with Gradient Structures, US Patent Publication No. 2005/0059760.

In the second part of this invention we describe the preparation of new surfaces of the nanocomposite products by migrating nanoparticles to the surface of the nanocomposite products, thereby increasing the concentration of the nanoparticles on the surface. These enhanced surfaces improve the mechanical properties of the surface such as hardness.

Another feature of this invention is illustrated by a recent surprising finding that pertains to the effect of the size of the nanoparticles on the migration process. Nanoparticles with a high aspect ratio of above 50, such as organically layered montmorillonite (OMMT), were found to migrate only to surfaces in which the condensed matter interfaces with air. If the condensed matter, that is, the polymeric matrix, interfaces for example with aluminum foil or any other solid surface, no migration to this surface occurs. This result corresponds to the requirements of the Gibbs isotherm. This enables the preparation of products in which only surfaces interfacing with air are enriched with nanoparticles by migration. Other surfaces will have the chemical composition of the bulk.

Additionally, we found an entirely different behavior in the case of smaller nanoparticles with diameters of 0.5-20 nm. Here the spontaneous migration of these nanoparticles such as POSS is more rapid than that of OMMT and proceeds not only to the matrix-air interface surface, but to all other surfaces at a similar rate. In the case of these small particles the Gibbs isotherm discussed above applies similarly to OMMT, but it cannot explain the migration to surfaces other than matrix interface surfaces. These other causes for the migration appear to be concerned with the cohesive energy between the POSS particles and the chains of the matrix on which it resides, and with the dynamics of the chain movements. In the case of these small particles, the migration is also enhanced by the polarity of the matrix chains. Compatibilization of the polymeric matrix will increase the rate and extent of migration. The presence of mildly oxidizing agents will increase the polarity of the matrix and enhance the migration.

We also surprisingly found that the migration in the case of the low aspect ratio nanoparticles occurs below the melting point in the solid state in a similar way as above the melting point. This appears to be a consequence both of the small dimensions of these nanoparticles as well as of the difference in surface tension between them and the matrix molecules. The rate of migration below the melting point can also be accelerated similarly to OMMT by increasing the temperature through heating or annealing.

### General Illustrative Methods and Products

Representative embodiments of the first part of this invention deal with the preparation of a nanocomposite from a nonpolar polymer with nanoparticles. According to the invention, in order to obtain a dispersion of the nanoparticles such as montmorillonite in a nonpolar polymer, for example, polypropylene or polyethylene, a compatibilization of the polymer is needed. This invention discloses a new way of compatibilization of the nonpolar polymer by applying a mild oxidizing agent. The oxidizing agent can be chosen from the group consisting of organic peroxides and hydroperoxides, inorganic nitrates, organic nitro derivatives, persulfates, perborates, air, mixtures of air and nitrogen, and mixtures of oxygen with air or nitrogen. The choice of the oxidizing agent depends on the polymer as well as on the nature of the nanoparticle used for the preparation of the nanocomposite. The concentration of the oxidizing agent and the time and temperature of its mixing in the Brabender with the polymer can be chosen according to the desired result.

In one illustrative embodiment of this invention involving blending polypropylene with 5 wt % of organically treated montmorillonite, 1 wt % of a hydroperoxide calculated on the weight of polypropylene is applied at a temperature of 190° C. for 5 min. In another illustrative embodiment, instead of hydroperoxide, a stream of air is introduced during Brabender mixing of the blend for 4 min. In another illustrative embodiment, a measured amount of air, together with a measured amount of hydroperoxide, is mixed in the Brabender together with the blend for 5 min. In another illustrative embodiment of this part of the invention, 0.5 wt % of an inorganic nitrate is added to the blend and mixed in a Brabender at 190° C. for 5 min. In yet another illustrative embodiment of this invention, polypropylene is mixed in the Brabender with octoisobutyl polyhedral oligomeric silsesquioxane (oibPOSS), with the addition of 0.5 wt % of a hydroperoxide at 190° C. for 5 min.

One embodiment of the second part of the invention is a method for preparing a nanocomposite in which the surface has a different chemical composition than the interior bulk, the method comprising the steps of (a) dispersing nanoparticles in a molten polymer or in a polymer dissolved in a suitable solvent in the presence or absence of a mild oxidizing agent; and (b) annealing the nanocomposites at a temperature above the glass transition temperature (T_{g}) for a predetermined time, thereby accelerating migration of the nanoparticles to the surface and thus increasing the concentration of the nanoparticles at the surface, and obtaining a lower concentration of the nanoparticles in the interior bulk. The addition of the mild oxidizing agent will be necessary in case the nonpolar polymer has not been compatibilized before. The oxidizing agent will then compatibilize the polymer and enable the dispersion of the nanoparticle in the polymer and the formation of the nanocomposite. If however the polymer has been compatibilized before, either according to part one of this invention or by any other method, the oxidizing agent will not be needed.

Important features of this invention include the extent to which the migration process may proceed, and the high concentrations of nanoparticles at the surface. In addition, the size of the nanoparticles used in the preparation of the nanocomposite is of considerable importance as mentioned above. Nanoparticles like those of montmorillonite have a high aspect ratio of several hundred, whereas other nanoparticles such as POSS included in this invention have the dimensions of 0.5-20 nm with a lower aspect ratio. The high aspect ratio nanoparticles migrate only to the polymer-air interface surface and do not migrate to the other surfaces in which the polymer does not interface with air. However, we surprisingly found that the low aspect ratio such as POSS migrates to all surfaces whether interfaced with air or with solid surfaces.

Another embodiment of the second part of the invention is a method for preparing new polymeric nanocomposite products. The product is a blend of nanoparticles and a polymer and has a surface of different chemical composition than the interior bulk. The method entails annealing the blend of the nanoparticles with the polymer at temperatures below or above the melting point for a predetermined time, wherein the concentration of the nanoparticles at the surface becomes greater than the concentration before annealing. For example, the surface concentration of nanoparticles can be up to 250% greater than the concentration of the nanoparticles before annealing. For another example, the surface concentration of nanoparticles can be up to 500% greater than the concentration of the nanoparticles before annealing. For another example, the surface concentration of nanoparticles can be 150% to more than 1400% greater than the concentration of the nanoparticles before annealing. In one exemplary embodiment of the invention, the surface of the nanocomposite can comprise at least 50% polyhedral oligomeric silsesquioxane.

In preferred embodiments of the invention, nanoparticles can be selected from the group consisting of POSS, montmorillonite, and organically treated montmorillonite, preferably in the exfoliated form. Also in preferred embodiments of the invention, the polymer can be selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN). Also in preferred embodiments of the invention, the oxidizing agent can be selected from the group consisting of air, organic peroxides, organic hydro peroxides, and inorganic nitrates.

In other preferred embodiments of the invention, the annealing can be carried out from a temperature of about 20° C. to about 350° C. For example, the annealing can be carried out for a time period of about 1 second to about 1 year, or alternatively from about 1 second to about 1 day, or alternatively from about 1 second to about 2 hours. For example, the annealing can be accomplished using microwave radiation. For example, the annealing can be carried out in an atmosphere comprising N₂ and O₂ so as to decrease sublimation of migrated nanoparticles from the surface of the nanocomposite.

In other embodiments of the invention, after dispersing the nanoparticles in the polymer in the presence of the oxidizing agent so as to form the nanoparticle/polymer blend, plastic products of various shapes and sizes made of the nanoparticle/polymer blend can be prepared. These plastic products can be heated in microwave ovens or by other means to affect the migration of the nanoparticles to all surfaces of the plastic product. Thus all the surfaces of the plastic product will have a higher concentration as compared to the inside bulk. The protective action of the high concentration of nanoparticles will thus pertain to the whole plastic product.

The following examples are illustrative of the invention:

Preparation of Nanocomposites of Polypropylene

In samples 1-5, 100 grams of pristine polypropylene were blended with 5 grams of IP-44 clay (produced by Southern Clay Products, Inc.) and a given wt % of tertiary butyl hydro peroxide (TBH) was blended in the Brabender at 190° C. for 5 min. at a rotation of 40 rpm. The interlayer distance (d) of the gallery between the 2 layers of aluminosilicate indicates the extent of intercalation of the polymeric chains into the gallery and serves as a measure of the degree of dispersion. As seen in Table 1, (d) increases with the increase in TBH, indicating the increase in intercalation typical for a nanocomposite. This presents full evidence for the formation of a nanocomposite upon addition of TBH. A mild oxidation of polypropylene occurs and introduces sufficient polar groups in the polypropylene which make the intercalation possible.

TABLE 1
Effect of TBH Concentration on Interlayer Distance (d)

| | (a) = Wt % | (d) = XRD |
|---|---|---|
| Example No. | TBH | interlayer distance |
| 1 | 0.0 | 2.53 |
| 2 | 0.5 | 2.97 |
| 3 | 0.75 | 3.24 |
| 4 | 1.0 | 3.45 |
| 5 | 2.0 | 3.65 |

TBH: Tertiary Butyl-Hydroperoxide
XRD: X-Ray Diffraction

Examples 6-14 show the mechanical properties of the samples treated at a series of concentrations of TBH for several times of mixing. Mechanical tests were carried out on a dynamic mechanical analyzer modulated DMA 2980 (TA Instruments, New Castle, Del.). The tensile strength, elongation and modulus were measured by using the film tension clamp in the controlled forced mode, and the ramp force was 3 N/min to 18 N. As shown in Table 2, the results show that in spite of the various concentrations of TBH and times of mixing the mechanical properties are only slightly changed. The tensile strength which for the pristine PP is 27.38 is found in all examples 6-14 to vary in the range of 26.22-28.56 Mpa close to the value of the control 27.38 Mpa. The Modulus of all samples 7-14 is higher than the control. They vary in the range of 1.674-2.241 Gpa. It is evident that all samples treated with TBH show a strongly increased Modulus. In five of the examples the Modulus is above 2 Gpa, i.e. 30% higher than the control. In the case of examples 8 and 10 the increase in the Modulus amounts to 45%. These results serve as additional evidence for the formation of the nanocomposites due to the effect of the TBH. The elongation break is seen in all examples 7-14 to be lower than the control. The values obtained are in the range of 10.23-15.6. Such a decrease in elongation generally occurs when particles are added to a polymeric melt. The values obtained are in the range of elongations acceptable in the trade and are not considered as evidence of undue damage.

TABLE 2
Mechanical Properties of TBH-Treated Nanocomposites

| | (a) | (b) | (c) | (d) | (e) |
|---|---|---|---|---|---|
| Example | wt % | Mixing | Elongation | Tensile | Modulus |
| No. | TBH | Time (min) | (%) | Strength (Mpa) | (Gpa) |
| 6 | 0 | 5 | 28.5 | 27.38 | 1.53 |
| 7 | 0.5 | 5 | 15.6 | 28.56 | 2.038 |
| 8 | 0.5 | 7.5 | 13.34 | 27.94 | 2.215 |
| 9 | 0.5 | 10 | 12.63 | 28.29 | 1.966 |
| 10 | 0.75 | 5 | 13.46 | 28.00 | 2.241 |
| 11 | 0.75 | 7.5 | 11.66 | 26.22 | 2.102 |
| 12 | 0.75 | 10 | 10.23 | 27.66 | 2.010 |
| 13 | 1 | 5 | 11.72 | 27.76 | 1.674 |
| 14 | 2 | 5 | 11.31 | 27.33 | 1.856 |

Examples 15-17 show that an inorganic nitrate such as AN is capable of effecting a compatibilization of PP similarly to organic hydro-peroxide. AS shown in Table 3, the d value increases with the increase in concentration of AN. The values obtained are similar to the values in Table 1 for TBH for similar concentrations of oxidant.

TABLE 3
Interlayer Distance (d) of
Ammonium Nitrate (AN) Treated Nanocomposites

| Example No. | (a) AN wt % | (b) d Value, nm |
|---|---|---|
| 15 | 0.5 | 3.15 |
| 16 | 1.0 | 3.35 |
| 17 | 1.5 | 3.43 |

Examples 18 and 19 in table 4 show that a compatibilization can also be obtained with an organic Nitrate derivative such as NB. As shown in Table 4, the affectivity of NB however is smaller than that of AN and TBH. A concentration of 1% NB yields a value of 2.96 only albeit a compatibilization occurs.

TABLE 4
Interlayer Distance (d) of Nitrobenzene (NB)-Treated Nanocomposites

| Example No. | (a) NB wt % | (b) d Value, nm |
|---|---|---|
| 18 | 0.5 | 2.57 |
| 19 | 1.0 | 2.96 |

### Example 20

Similar results are obtained when a mixture of pristine polypropylene with 5% clay is prepared by mixing in a Brabender for 5 minutes at 190° C. at 40 rpm. No dispersion of the clay occurs during the mixing. When a sample of the mixed material is placed in a thermostat and heated to 190° C. for 60 minutes at this temperature under a stream of nitrogen containing 12.5% of air, a nanocomposite is formed, as evidenced by XRD. A d value of 3.11 is obtained. This indicates that a small percentage of air in the nitrogen is sufficient to produce enough polar groups in the polypropylene to affect the dispersion of the clay and the formation of a nanocomposite. See Table 5.

TABLE 5
Compatibilization of PP in the Presence of Air

| Example No. | (a) Mixing time | (b) d value, nm |
|---|---|---|
| 20 | 0 | 2.53 |
| 21 | 3 | 3.15 |
| 22 | 5 | 3.49 |

Examples 21 and 22 in Table 5 teach that introduction of air into the Brabender during mixing of the PP with the organically layered montmorillonite (OMMT) brings about a compatibilization of the PP as evidenced by the increase in the d values. Prolonging the time of mixing in the presence of air from 3 minutes to 5 minutes increases the extent of the compatibilization due to the formation of oxidized polar groups as evidenced by the increase in the d value.

### Preparation of New Surfaces

### Example 23

The sample prepared in Example 20 also is heated for 60 minutes, but the percentage of air in the purging gas is 50%. The d value from XRD is 3.51. The sample then is cooled and its surface is examined spectroscopically by ATR-FTIR. The height of the peak at 1043 cm⁻¹ normalized to the peak of 1375 cm⁻¹ (CH₃ symmetric deformation) indicates the concentration of SiO on the surface, i.e. the concentration of the clay. A value of r₁=1.73 is obtained. This value is 3.6 times higher than the value of the control, r₀, of the sample obtained after the Brabender mixing and before annealing. The ratio r₁/r₀=r₂, where r₂×100 indicates the percent increase in the concentration of the clay on the surface after 60 minutes of annealing due to migration (r₂ is also called the migration index (MI)). This means that if the initial concentration of the clay on the surface after the Brabender was 5 wt %, the concentration after annealing according to Example 23 is 3.6×5=18, i.e. an increase of 360%.

### Example 24

A sample of the mixture of Example 20 is annealed for 60 minutes under a stream of air. The r₂ value is r₁/r₀ and equals here 4.35, i.e. the concentration of clay on the surface after the annealing is 4.35×5=21.75. When comparing Example 24 to Example 23 it can be seen that the increase in percentage of air from 6.25% to 50% in the purging gas increases greatly the extent of migration and consequently the concentration of the clay on the surface.

### Example 25

Polypropylene containing 0.5% of grafted maleic anhydride is mixed in a Brabender with 5% OMMT for 5 minutes at 190° C. A sample of the mixture is annealed under a stream of 25% air at 225° C. for 60 minutes. The r₁=2.82, r₂=6.88 and r₀=0.41. This means that the concentration of clay on the surface is 6.88×5=34.4.

### Example 26

A sample of polypropylene containing 1.5% grafted MA was tested on the Rockwell Hardness tester. A value for hardness was obtained of 66.35±3.43 N/mm².

### Example 27

Polypropylene containing 1.5% grafted MA was mixed in a Brabender with 5% OMMT for 5 minutes at 190° C. at 40 rpm. A sample of this mixture after cooling was tested in the Rockwell Hardness tester. A hardness of 75.55±12.91 N/mm² was obtained. It is seen that the nanocomposite containing 5% OMMT has an increased hardness of 13.9% due to the presence of the clay on the surface.

### Example 28

A sample of the mixture of Example 27 was annealed at 180° C. for 60 minutes under the presence of 12.5% of air. The r₁ of the annealed sample was 0.97, r₀=0.47 and r₂=2.06, i.e. the concentration of clay on the surface was 10.3 wt %. The hardness value obtained was 112.75±13.21 N/mm². The increase in the clay concentration on the surface from 5% in Example 27 to 10.3% in Example 28 brought about an increase of 49.2% in the hardness.

Other kinds of nanoparticles also are being used to produce nanocomposites. These particles include several varieties of POSS. The POSS derivatives are different from the clays. They are not composed of two aluminosilicate layers close to each other with a gallery between them and in which positive ions such as Na⁺ exist and neutralize the negative charges of the aluminosilicate layers. POSS constitutes a cage composed of (SiO_{1.5}) R₈, which is silicon and oxygen in a ratio of 1:1.5, located on the eight corners of an eight-cornered cage. Various organic groups can be linked so that a variety of POSS derivatives can be produced.

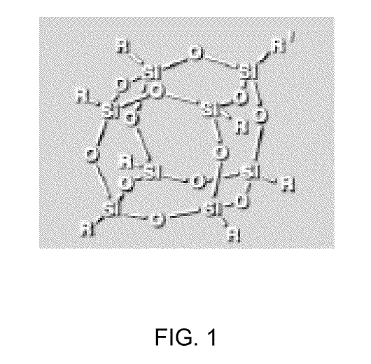

The following examples pertain to an octoisobutile POSS (oibPOSS) as seen in FIG. 1. OibPOSS is a non-polar compound. In the examples, a blend of POSS was prepared with a polymer such as polypropylene in which the POSS is dispersed, and a nanocomposite was obtained that has many properties similar to a clay based nanocomposite with regard to mechanical, thermal and optical properties. The preparation of the dispersion was carried out as follows: PP+5 wt % of POSS were mixed in a Brabender for 5 minutes at 190° C. and 40 rpm. About 5 g samples were transferred into a mold (4 mm×1 cm×4 cm), and then the samples together with the mold were pressed into a test bar at 190° C. by using a Carver Press (Model #33500-328). The bars were tested by Attenuated Total Reflection Fourier Transform Infrared Spectroscopy (ATR-FTIR). For the concentration of POSS the peak in the spectrum was at 1110 cm⁻¹ and normalized to 1375 cm⁻¹. The value obtained, r₀, corresponding to the concentration of POSS before annealing, was determined. This sample was termed the control sample.

Surprisingly, if a sample of the PP-oibPOSS blend was placed in a thermostatic oven and annealed at a temperature above the melting point of PP, a very pronounced rapid migration of POSS to all surfaces of the sample was observed. This migration occurs whether the purging gas is composed of N₂ alone or N₂ with various concentrations of air. The extent of migration of the POSS was monitored by recording the value of the ATR-FTIR peak at 1110 cm⁻¹, after normalizing it to the peak of 1375 cm⁻¹. The migration proceeds to all surfaces of the sample. Increased concentration of POSS on the bottom surface as well as on the top surface of the sample was observed. When the annealing was carried out at 190° C., the concentration of POSS on the bottom surface was higher than on the top surface. This difference is due to a sublimation of POSS from the top surface, which was open to air, while the bottom surface was not open to the air. Upon increasing the concentration of air in the purging gas, the amount of POSS sublimated from the surface decreased. This indicates that air oxidizes the organic groups of the POSS to non-volatile moieties, and probably crosslinks between the POSS cages are formed.

The migration in the case of POSS is thus different from the migration of OMMT. In Examples 20, 25 and 27, in which the migration of OMMT was described, the migration proceeded only to the upper surface of the sample in which the surface interfaces with air. No migration was observed to the bottom surface which interfaced with aluminum foil. This behavior appears to be typical for nanoparticles with a high aspect ratio which in the case of OMMT is several hundred. POSS on the other hand is a small particle with a diameter of ca. 0.5-4 nm. In this case, the migration proceeds according to a different mechanism. Whereas in the case of OMMT the migration occurs according to the Gibbs adsorption isotherm, which requires that components of a blend with a lower surface tension migrate to the polymer air interface surface, in the case of small particles such as POSS the migration is governed not only by the Gibbs isotherm but also according to other causes.

Examples 29-36 were prepared according to Example 29. About 5 g samples were transferred into a mold (4 mm×1 cm×4 cm), and then the samples together with the mold were pressed into a test bar at 190° C. by using a Carver Press (Model #33500-328). The obtained bar was covered with aluminum foil, leaving one surface uncovered, and then positioned into a syringe. The syringe was sealed with a silicone rubber. The syringe was then heated in a thermo stated isotemp furnace (Fisher Scientific Company) for 30 minutes. The actual temperature during annealing was monitored by a thermocouple. These samples were annealed under a stream of N₂, or N₂ containing specified ratios of air, controlled by two calibrated flowmeters. The flow rate of the purging gas was 800 ml/min. The determination of the concentration of POSS was carried out on the top as well as on the bottom surfaces.

TABLE 6
Migration by Annealing PP-POSS Nanocomposites

| | | ATR | | | |
|---|---|---|---|---|---|
| Example | | Top Surface | | Bottom Surface | |
| No. | % Air | R₁ (1110 cm⁻¹) | r₂ | r₁ (1110 cm⁻¹) | r₂ |
| 29 | | R₀ = 0.76 ± 0.14 | 1 | r₀ = 0.76 ± 0.14 | 1 |
| 30 | Only N₂ | 1.12 ± 0.27 | 1.47 ± 0.36 | 2.78 ± 0.56 | 3.66 ± 0.74 |
| 31 | 12.5 | 1.53 ± .036 | 2.01 ± 0.47 | 2.88 ± 0.74 | 3.79 ± 0.97 |
| 32 | 100 | 1.92 ± 0.47 | 2.53 ± 0.62 | 2.91 ± 0.75 | 3.83 ± 0.99 |

TABLE 7
Migration by Annealing PPMA-POSS Nanocomposites

| | | ATR | | | |
|---|---|---|---|---|---|
| Example | | Top Surface | | Bottom Surface | |
| No. | % Air | R₁ (1110 cm⁻¹) | r₂ | r₁ (1110 cm⁻¹) | r₂ |
| 33 | | R₀ = 1.19 ± 0.03 | 1 | r₀ = 1.19 ± 0.03 | 1 |
| 34 | Only N₂ | 5.12 ± 0.47 | 4.30 ± 0.39 | 5.33 ± 0.87 | 4.48 ± 0.73 |
| 35 | 12.5 | 5.30 ± 0.79 | 4.45 ± 0.66 | 5.48 ± 0.74 | 4.61 ± 0.62 |
| 36 | 25 | 5.49 ± 0.98 | 4.61 ± 0.82 | 5.68 ± 0.74 | 4.71 ± 0.62 |

TABLE 8
Migration in Microwave Oven

| | Heating in | ATR | | | |
|---|---|---|---|---|---|
| Example | Microwave | Top Surface | | Bottom Surface | |
| No. | Oven (min) | r₁ (1110 cm⁻¹) | r₂ | R₁ (1110 cm⁻¹) | r₂ |

PPMA

| | | | | | |
|---|---|---|---|---|---|
| 33 | | r₀ = 1.19 ± 0.03 | 1 | R₀ = 1.19 ± 0.03 | 1 |
| 37 | 4 | 2.89 ± 0.87 | 2.43 ± 0.73 | 1.92 ± 0.41 | 1.61 ± 0.84 |
| 38 | 8 | 5.09 ± 0.90 | 4.28 ± 0.76 | 4.95 ± 0.81 | 4.16 ± 0.71 |
| 39 | 12 | 6.83 ± 1.08 | 5.74 ± 0.91 | 6.73 ± 1.17 | 5.66 ± 0.98 |
| 40 | 16 | 7.83 ± 1.24 | 6.58 ± 1.04 | 8.17 ± 0.63 | 6.87 ± 0.53 |
| 41 | 20 | 11.21 ± 1.26 | 9.42 ± 1.06 | 12.38 ± 1.29 | 10.40 ± 1.08 |

PP

| | | | | | |
|---|---|---|---|---|---|
| 29 | | r₀ = 0.76 ± 0.14 | 1 | R₀ = 0.76 ± 0.14 | 1 |
| 42 | 4 | 1.22 ± 0.17 | 1.60 ± 0.22 | 1.09 ± 0.37 | 1.43 ± 0.49 |
| 43 | 8 | 1.98 ± 0.40 | 2.61 ± 0.53 | 1.92 ± 0.71 | 2.53 ± 0.93 |
| 44 | 12 | 2.63 ± 0.71 | 3.46 ± 0.93 | 2.26 ± 0.26 | 2.97 ± 0.34 |
| 45 | 16 | 3.43 ± 0.73 | 4.51 ± 0.96 | 3.94 ± 0.82 | 5.18 ± 1.08 |
| 46 | 20 | 5.22 ± 0.49 | 5.22 ± 0.49 | 5.76 ± 0.66 | 7.58 ± 0.87 |

### Example 30

A sample was prepared according to Example 29 and was annealed at 190° C. for 30 minutes under a stream of N₂. The sample then was cooled and tested by ATR-FTIR on the top surface and on the bottom surface. The values of r₁ and r₂ on the bottom surface are 2.78±0.56 and 3.66±0.74, respectively. The values of r₁ and r₂ on the top surface were 1.12±0.27 and 1.47±0.36, respectively. The difference in the amount of POSS between the top and the bottom surfaces is 60%−the top surface lost 60% of the migrated POSS due to sublimation.

### Example 31

A sample was prepared and annealed in a manner similar to Example 30. However, 12.5% of air was included in the N₂ stream. The value of r₂ on the bottom surface changed only slightly, but the value of r₂ on the top increased to 2.01±0.47.

### Example 32

A sample was prepared and annealed in a manner similar to Example 30. However, air instead of N₂ was used for purging the sample during annealing. The value of r₂ on the bottom changed slightly, but the value of r₂ on the top is 2.53±0.62.

It is seen in these examples that the amount of sublimated POSS can be decreased by using increasing amounts of air in the purging stream of gas. It can be deduced that when increasing the rate of flow of the gas purging the sample and thus applying more air per minute, a smaller amount of POSS sublimates and the yield of migrated POSS increases on the top surface.

Example 33 describes the preparation of the control sample in which PPMA (1.5% MA) was melt blended with 5% POSS according to the conditions of Example 29.

Surprisingly, if some polarity is introduced in the PP molecules, for example if 1.5% of maleic anhydride (MA) are grafted to the PP molecules, the results obtained upon annealing this blend of PPMA with 5% oibPOSS are different, as can be seen in Examples 33-36. In the case of the PPMA-oibPOSS blends, the extent of migration (MI) increases by about 20%, as is evident when comparing the r₂ value of Example 34 on the bottom surface (i.e., 4.48) to that of Example 30 (i.e., 3.66). The migration in Examples 30-36 theoretically is due to the polarity of the PPMA, similar to the case of the clay-based nanocomposites disclosed earlier. It is to be expected that an increase in the polarity of the matrix polymer will increase the MI of POSS. Those of skill in the art will be able to control the MI by using different polarized polymers without undue experimentation.

Examples 33-36 show that the values of r₂ in the sample annealed under N₂ (Example 34) as well as under an N₂ stream containing up to 25% air (Example 36) obtained on the top and bottom surfaces are approximately the same. This indicates that there is no significant sublimation occurring in the case of the polarized PP.

Another surprising feature of this invention is the finding that the migration process can occur on polymer POSS blends also below the melting point, i.e., on the solid samples and at lower temperatures. Samples similar in size and composition to those of Examples 29 and 33 were heated in a household microwave oven (Galaxy brand microwave oven, model 721.64002). The use of microwave energy for processing materials has the potential to offer advantages in reduced processing times and energy savings. In conventional thermal processing, energy is transferred to the material through convection, conduction, and radiation of heat from the surfaces of the material. During this heating in the microwave oven, the energy is transferred at a molecular level, which opens new possibilities. An important advantage of the microwave heating is that it heats simultaneously the whole sample and does not require time for the heat to spread to the interior of the sample, resulting in homogeneous samples.

As seen from Examples 37-46, in both PPMA and PP-POSS blends the MI values increase with increase in time of heating.

### Example 37

This describes a sample prepared according to Example 33 and heated in the microwave for 4 minutes. The value of r₂ on the top surface and on the bottom surface are the same when considering the experimental error. The temperature of the sample at the end of the 4 minutes was 96° C. The sample was heated at this temperature for only about 1 minute as it took 3 minutes of heating to bring it up to this temperature.

### Example 38

The sample from Example 37, after cooling in a desiccator, was heated for an additional 4 minutes. The r₂ value obtained for the top and bottom surfaces was approximately 4.2, which shows a very considerable increase from Example 37.

### Example 39

This describes a sample prepared according to Example 33 that was cooled and heated for another 4 minutes, i.e. altogether the sample was heated for 12 minutes. The r₂ value obtained for the top and bottom surfaces was approximately 5.7 showing an additional increase in the extent of the migration.

### Example 40

This describes a sample prepared according to Example 39 that was cooled and heated for another 4 minutes. The r₂ value obtained for the top and bottom surfaces was approximately 6.7, showing an additional increase in the extent of the migration. The difference in the r₂ values for the top and bottom surfaces seems to be small.

### Example 41

This describes a sample prepared according to Example 40 that was cooled and heated for another 4 minutes. The r₂ value obtained for the top and bottom surfaces was approximately 10, showing an additional increase in the extent of the migration, which, when considering the initial POSS concentration in the control sample was 5%, amounts to 50% POSS on the surface after 20 minutes of heating, that is an increase of 1000% in the concentration of POSS on the surface as compared to the concentration of the control.

Examples 42-46 pertain to samples prepared from pristine PP+5 wt % oibPOSS.

### Example 42

This describes a sample prepared according to Example 29 and heated similarly to Example 37 for 4 minutes in the microwave oven. The value of r₂ for the top and bottom surfaces is approximately the same and amounts to 1.6. It behaves in a similar way as the samples based on PPMA but with a lower rate of migration.

### Example 43

The sample obtained according to the procedure of Example 42 was heated in the microwave oven for additional 4 minutes. The r₂ values for the top and bottom surfaces increases to approximately 2.58.

### Example 44

This sample relates to the sample from Example 43 that was cooled and heated for an additional 4 minutes, i.e. the sample was heated altogether for 12 minutes. The r₂ values for the top and bottom surfaces increases to approximately 3.25.

### Example 45

This sample relates to the sample from Example 44 that was cooled and heated for an additional 4 minutes, i.e. altogether for 16 minutes. The r₂ values for the top and bottom surfaces increases to approximately 4.84.

### Example 46

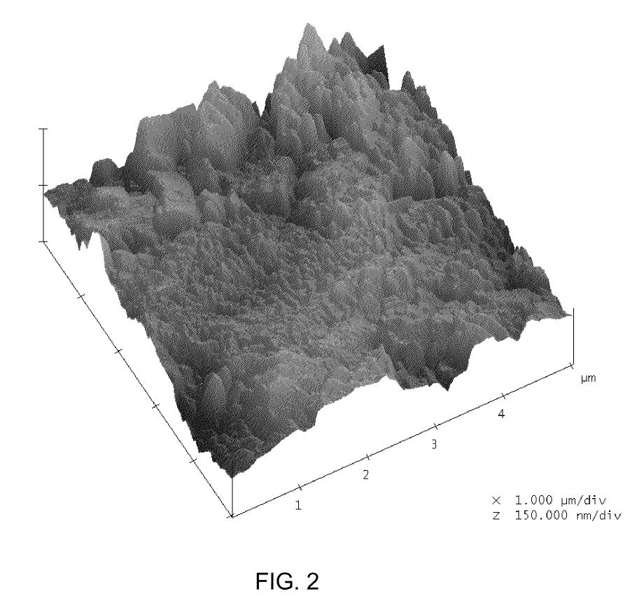

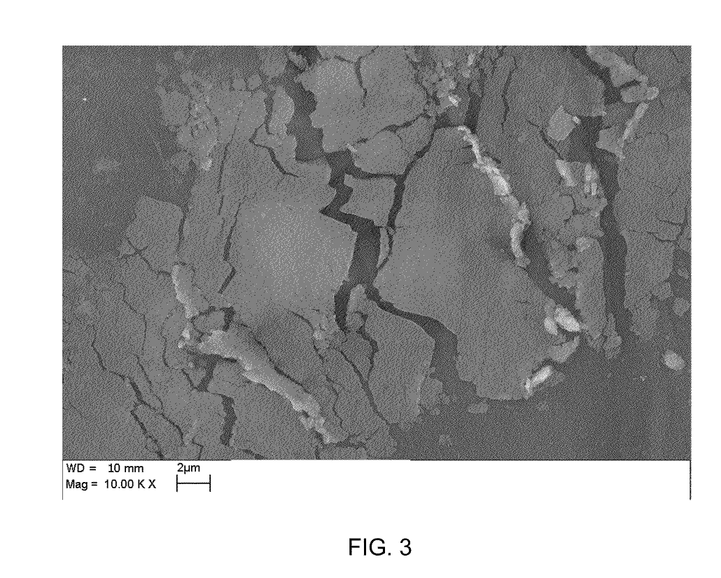

This sample relates to the sample of Example 45 that was cooled and heated for an additional 4 minutes, i.e. altogether for 20 minutes. The r₂ values for the top and bottom surfaces increases to approximately 6.4. This value is markedly lower than the value obtained under the same heating conditions for the PPMA blend in Examples 37-41. FIG. 2 is an AFM image of the surface resulting from Example 46. FIG. 3 is an SEM image of the surface resulting from Example 46.

The average value of the MI for Examples 37-41 is higher by 47% then that of Examples 42-46. This difference is higher than the 20% discussed earlier in the cases of the annealing at 190° C. of PP-POSS and PPMA-POSS. This higher rate of migration is attributed to the higher efficiency of heating of polarized polymers in the microwave oven.

### Example 47

High density polyethylene (HDPE) was melt mixed in a Brabender at 135° C. for 5 minutes. About 5 g samples were transferred into a mold (4 mm×1 cm×4 cm), and then the samples together with the mold were pressed into a test bar at 135° C. by using a Carver Press (Model #33500-328). The bars were tested by ATR-FTIR for the concentration of POSS peak in the spectrum at 1110 cm⁻¹ and normalized to 2920 cm⁻¹. The value obtained, r₀, corresponding to the concentration of POSS before annealing, was determined. This sample was termed the control sample.

The obtained bar was covered with aluminum foil, leaving one surface uncovered, and then positioned into a syringe. The syringe was sealed with a silicone rubber. The syringe was then heated in a thermostated isotemp furnace (Fisher Scientific Company) for 30 minutes. The actual temperature during annealing was monitored by a thermocouple. The sample was annealed at 135° C. under a stream of N₂ for 30 minutes, controlled by a flowmeter. The flow rate of the purging gas was 800 ml/min. The sample was then cooled and tested by ATR-FTIR on the top surface and on the bottom surface. The r₂ values are 2.73±0.97 and 6.33±1.04, respectively.

### Example 48

PA6, Ultramide B-3 NC010 was melt mixed in a Brabender at 240° C. for 5 minutes and 40 rpm. About 5 g samples were transferred into a mold (4 mm×1 cm×4 cm), and then the samples together with the mold were pressed into a test bar at 240° C. by using a Carver Press (Model #33500-328). The bars were tested by ATR-FTIR for the concentration of POSS peak in the spectrum at 1110 cm⁻¹ and normalized to 1640 cm⁻¹. The value obtained, r₀, corresponding to the concentration of POSS before annealing, was determined. This sample was termed the control sample. This sample was heated for 50 seconds in a household microwave oven (heated in the same conditions like in Example 37, except the time was different). The temperature on the top surface was 150° C. as measured with an infra-red thermometer. The sample was then cooled and tested by ATR-FTIR. On the top surface, the value r₂ was 3.25±0.95.

The experiment described in Examples 37-41 shows that a very high MI can be obtained upon stepwise heating a sample with cooling between the heating steps. Similar results can be obtained also by one stage heating without cooling in between. For example, a sample similar to Example 41 was prepared and was heated for 10 minutes in the same microwave oven. An MI of 70 on the bottom surface was obtained; however the MI of the top surface was found to be significantly lower due to sublimation. The longer the sample is heated in the microwave oven, the higher the temperature reached, and in this example the temperature reached was 120° C. At this temperature sublimation occurs and the MI of the top surface decreases. In order to avoid the decrease in MI due to sublimation, a lower temperature is preferable and this can be achieved by stepwise heating. Very high MI without sublimation can be obtained in the case of PP or PPMA-POSS nanocomposites by adapting a suitable stepwise heating schedule with the appropriate temperature, and those skilled in the art can plan such production schedules without undue experimentation. This is another feature of the present invention that concerns the method and schedule of annealing or heating in order to achieve migration, and is of particular importance when processing polar polymers. The rate of heating in the microwave oven increases greatly with the polarity of the polymer, as can be seen in Example 48 in which the temperature of the polyamide POSS blend sample reached a temperature 150° C. after only 50 seconds. Applying a stepwise schedule enables the design of suitable procedures for obtaining various degrees of MI for a variety of polymers.

One feature of the present invention is that the migration proceeds in all directions of the polymer-POSS blend product when heated in the microwave oven. For example, when ball bearings made of a polymer-POSS nanocomposite with a relatively low POSS content such as 5 wt % are heated in the microwave oven, the POSS will migrate to all the surfaces of the ball so as to obtain a surface rich with POSS. Depending on the schedule of the heating in the commercial microwave oven, surfaces containing up to 60% of POSS and higher can be obtained in a relatively short time and in such a way to produce a new product that can be termed second generation nanocomposite. This surface is believed to have a very low friction coefficient, low wear and high abrasion resistance, which can be the characteristics of new ball bearings and other products of low friction surface that could be used advantageously for many applications. The low friction is clearly evidenced by atomic force microscopy (AFM) measurements of surface roughness, measured in root mean square roughness (RMS nm); in a diameter of the rough domains, the higher the RMS and the diameter, the lower the friction. As can be seen in Table 9, the roughness increases dramatically with the migration of the samples. The high percentage of POSS will also impart to the product a very high hydrophobicity due to the low surface tension of POSS which is close to that of Teflon brand fluoropolymers.

TABLE 9
AFM Particle Size Analysis of the Studied Samples (see FIG. 2)

| Sample | RMS (nm) | Diameter (nm) |
|---|---|---|
| Pristine PP | 4.02 | 28.93 |
| PP/5 wt % POSS (control) Example 29 | 7.08 | 41.05 |
| PP-oib-POSS (20 min) Example 46 | 29.57 | 85.25 |
| PPMA-oib-POSS (20 min) Example 41 | 44.57 | 116.04 |

Note:
RMS is root mean square roughness

Atomic Force Microscopy (AFM). The AFM experiments in Table 9 were performed on a MultiMode scanning probe microscope from Veeco Instruments (Santa Barbara, Calif.). A silicon probe with 125 μm long silicon cantilever, and 275 kHz resonant frequency was used for tapping mode surface topography studies. Surface topographies of the chosen samples were studied on 5 μm×5 μm scan areas with a scan rate of ca. 1.1 Hz.

The static contact angle measurements with the probe liquids (i.e. ultrapure water) were carried out on a Cam 200 Optical Contact Anglemeter from KSV Instruments at room temperature. In can be seen in Table 10 that the contact angles of the surfaces with water increase dramatically with the increase of POSS on the surface of the samples. At a concentration of 50% POSS on the surface of a PPMA-POSS blend, a water contact angle value of 111° was obtained whereas the water contact angle of POSS itself with water reaches the value of 118°. Both values are close to the value of Teflon brand polytetrafluoroethylene. For the POSS concentration, a water contact angle value of 109.5° was obtained.

TABLE 10
Contact Angles with Water

| Sample | Water contact angle |
|---|---|
| Pristine PP | 79.8 |
| PP + POSS - Example 29 | 85.3 |
| PP + POSS (12 min) - Example 44 | 105.4 |
| PP + POSS (20 min) - Example 46 | 109.5 |
| Pure PPMA | 66.9 |
| PPMA + POSS - Example 33 | 88.02 |
| PPMA + POSS (12 min) - Example 39 | 104.5 |
| PPMA + POSS (20 min) - Example 41 | 111.12 |

As mentioned above, the principles of this invention apply to a large variety of nanocomposites prepared from many polymers of different polarity with many kinds of POSS depending on the structure of the side groups. The side groups may be composed of molecules containing additional silicon or other elements such as metallic derivatives, aromatic groups, polymeric groups, fluorine derivatives, and others. This will broaden much further the applications of POSS, especially after migration. Specific surfaces with specific properties may also be produced for a variety of additional uses.

The second generation nanocomposites as described herein have strongly enhanced surface properties. For example, for 5 and 10 wt % POSS containing PP, the hardness values obtained were (Misra R, Fu B X, Morgan S E. J Polym Sci: Part B: Polymer Physics 2007; 45: 2441]):
Pristine PP: 109 MPa.
5% POSS: 157 MPa.
10% POSS: 225 MPa.

The water contact angle for PP-oibPOSS blends found in the prior art literature increases from 72.95 for Pristine PP to 78.20 for 5 wt % POSS and to 86.10 for 10 wt % POSS. These values should be compared to the high values of 110-111 found according to the present invention for a similar PP-oibPOSS blend (see Table 10). These values are close to the value of 118 measured for pure oib-POSS and are close to the value for Teflon brand polytetrafluoroethylene. Similarly, the friction as measured by the ratio of the friction force/normal force decreases from 0.17 for Pristine PP to 0.14 for 5 wt % POSS and to 0.07 for 10 wt % POSS. It can be assumed that for 50% POSS a value close to or less than 0.03, the value for Teflon brand polytetrafluoroethylene, will be obtained (Misra R, Fu B X, Morgan S E. J Polym Sci: Part B: Polymer Physics 2007; 45: 2441).

These vastly enhanced properties resulting from the present invention will enable the production of a large number of products of highly improved properties, for example but not limited to low-friction carpets, high-wear ball bearings, and high-ware plastic windows.

Uses.

The improved nanocomposites of the present invention can have various uses of which the following are illustrative possibilities:

Producers of polyolefines, polypropylene, polyethylene and other polyolefines could produce compatibilized polar polymers for the production of nanocomposites.

Nanocomposites with enhanced surfaces according to this invention (second generation nanocomposites) would be of interest to producers of specialized nanocomposites for various applications such as for the production of low friction automotive and aircraft parts, low friction and high wear machines parts and textiles, anti-corrosive treatments, longer shelf life plastic products, and a number of other applications.

One representative product can be an air impermeable film having a high concentration of the nanoparticles on the surface that can be used for packaging food, protecting electronics, and other related uses.

The development of specialized membranes, especially asymmetric membranes for separation of materials, gases, ultrafiltration and possibly for desalination of water as well as for special filters of industrial off-gases and environmental waste.

The foregoing detailed description of the preferred embodiments and the attached background materials have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A method for preparing a nanocomposite, the nanocomposite having a surface and an interior bulk, the surface having a different chemical composition than the interior bulk, the method comprising the steps of:
a) dispersing nanoparticles in a molten polymer or in a polymer dissolved in a suitable solvent; and
b) annealing the nanocomposites for a predetermined time thereby accelerating migration of the nanoparticles to the surface of the nanocomposite and thus increasing the concentration of the nanoparticles at the surface of the nanocomposite,
whereby the nanocomposite has a higher concentration of the nanoparticles at the surface of the nanocomposite and a lower concentration of the nanoparticles in the interior bulk of the nanocomposite.

2. The method according to claim 1, wherein a mildly oxidizing agent is added while dispersing the nanoparticles in the molten polymer.

3. The method according to claim 1, wherein the nanoparticles are selected from the group consisting of clays and organically treated clays, montmorillonite and organically treated montmorillonite, silsesquioxanes and their derivatives.

4. The method according to claim 1, wherein the preparation of the nanocomposite is carried out in two steps:
a) the polymer is treated by the oxidizing agent at a predetermined concentration at a predetermined time of treatment; and
b) the oxidized polymer is blended with the nanoparticles.

5. The method according to claim 2, wherein the oxidizing agent forms an integral part of the nanoparticles or is included in them.

6. The method according to claim 1, wherein the polymer is selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN).

7. The method according to claim 2, wherein the oxidizing agent is selected from the group consisting of air, organic peroxides and hydroperoxides, and inorganic oxidizing agents, or mixtures thereof.

8. The method according to claim 5, wherein the oxidizing agent is a material selected from the group of sodium nitrate, potassium nitrate, lithium nitrate, ammonium nitrate, magnesium nitrate, aluminum nitrate, zinc nitrate, calcium nitrate, strontium nitrate, barium nitrate, and mixtures thereof, and of persulfates and perborates.

9. The method according to claim 5, wherein the oxidizing agent consists essentially of air and mixtures of air and nitrogen.

10. The method according to claim 5, wherein the oxidizing agent is selected from the group consisting of nitro benzene and tertiary butyl hydro peroxide.

11. The method according to claim 3, wherein the concentration of the nanoparticles on the surface of the nanocomposite is greater than the concentration of the nanoparticles in the interior bulk of the nanocomposite and comprises up to 99% of the composition of the surface of the nanocomposite.

12. The method according to claim 1, wherein the annealing is carried out at a temperature of from about 20° C. to about 350° C. for a time period of from about 1 second to about 1 year.

13. The method according ton claim 4, wherein the nanocomposite is converted into products of predetermined sizes and shapes, in which all surfaces contain concentrations of the nanoparticles higher by at least 25% than the interior bulk.

14. The method according to claim 1, wherein the annealing is carried out in an atmosphere of gasses selected from nitrogen, air, a mixture of nitrogen and air, a mixture of nitrogen with oxygen, and a mixture of oxygen and air.

15. The method according to claim 1, wherein the annealing is done in time limited steps and between each of the time limited steps the polymeric product is cooled down to room temperature.

16. A nanocomposite comprising a polymer and nanoparticles of the dimensions 0.5-4 nm thickness, and a width and length of 0.5-1000 nm, wherein the nanocomposite has a surface and an interior bulk and wherein the nanocomposite has a higher concentration of the nanoparticles at the surface of the nanocomposite and a lower concentration of the nanoparticles in the interior bulk of the nanocomposite.

17. The nanocomposite prepared according to claim 16, wherein the surface has a higher concentration by 25% of the nanoparticles than the interior bulk.

18. The nanocomposite as claimed in claim 16, wherein the nanoparticles are selected from the group consisting of clays and organically treated clays, montmorillonite and organically treated montmorillonite, silsesquioxanes (POSS) and their derivatives.

19. The nanocomposite as claimed in claim 16, wherein the polymer is selected from the group consisting of polypropylene (PP), polyethylene (PE), ethylene-propylene copolymer (EP), polyamide (PA), polyamide 6 (PA6), polyamide 66 (PA66), poly(ethyleneterephtalate) (PET), polycarbonate (PC), poly(methyl methacrylate) (PMMA), polyimide (PI), polyphenylene oxide, polystyrene, poly(butylene terephtalate) (PBT), ethylene-vinyl copolymer (EVA), polyurea, polyurethane (PU), polyacrylates, polyacrylonitril (PAN) and styrene-acrylonitrile (SAN).

20. The nanocomposite according to claim 17, wherein the nanocomposite is produced by a method comprising the steps of:
a) dispersing the nanoparticles in the polymer, the polymer being molten or dissolved in a suitable solvent; and
b) annealing the nanocomposites for a predetermined time thereby accelerating migration of the nanoparticles to the surface of the nanocomposite and thus increasing the concentration of the nanoparticles at the surface of the nanocomposite,
whereby the nanocomposite has the higher concentration of the nanoparticles at the surface of the nanocomposite and the lower concentration of the nanoparticles in the interior bulk of the nanocomposite.
